(19) United States
(12) Patent Application Publication
(10) Pub. No.: US 2026/0197231 A1
(43) Pub. Date: Jul. 9, 2026

(54) COMPUTING APPARATUS AND METHOD OF SEARCHING FOR COMMUNICATION LINK PERFORMED BY COMPUTING APPARATUS

(71) Applicant: ELECTRONICS AND TELECOMMUNICATIONS RESEARCH INSTITUTE, Daejeon (KR)

(72) Inventors: Jin Doo JEONG, Daejeon (KR); Il Woo LEE, Daejeon (KR)

(21) Appl. No.: 19/389,572

(22) Filed: Nov. 14, 2025

(30) Foreign Application Priority Data
Jan. 7, 2025 (KR) 10-2025-0002402

(51) Int. Cl. H04L 41/0803; H04B 7/0456; H04L 67/12

(52) U.S. Cl. CPC H04L 41/0803; H04B 7/0456; H04L 67/12

(57) ABSTRACT

Provided is a method of searching for a communication link, which is performed by a computing apparatus. The method includes generating a communication quality matrix based on a communication path between a communication node and a repeater, generating, based on the communication node, a usage frequency matrix according to whether a wireless communication signal passes through the repeater, extracting a communication quality pattern and a usage frequency pattern by applying the communication quality matrix and the usage frequency matrix to a communication link application model based on machine learning, and searching for a point where loss of the communication link occurs in the wireless communication network.

### CROSS-REFERENCE TO RELATED APPLICATION

This application claims the benefit of Korean Patent Application No. 10-2025-0002402, filed on Jan. 7, 2025, in the Korean Intellectual Property Office, the entire disclosure of which is incorporated herein by reference for all purposes.

### BACKGROUND

### 1. Field of the Invention

One or more embodiments relate to a computing apparatus and a method of searching for a communication link.

### 2. Description of the Related Art

According to the domestic power market statistics, the industrial sector accounts for 56% of the total proportion in terms of power consumption. This statistical result indicates that the industrial sector is the largest consumer of domestic energy and power consumption and also implies that reducing energy and power consumption in the industrial sector greatly contributes to energy conservation at the national level.

Recently, a factory energy management system (FEMS) for energy management in the industrial sector has been used, and the FEMS is based on monitoring the energy consumption of each energy resource used in the factory for energy efficiency according to energy management. That is, the industrial sector generally includes a poor channel environment for wireless communication technology, which is caused by metals, dust, vibration, etc., compared to other sectors. Accordingly, wired communication has been mainly used for resource/equipment monitoring and control in factories so far. However, with the advent of the fourth industrial revolution, wireless communication technologies, such as fifth generation (5G), have evolved to be used for factory networking construction to reduce networking construction costs and improve process flexibility, making it possible to select and apply, among industrial wireless communication technologies, wireless communication technologies suitable for FEMS networking to be built by considering networking construction factors such as functions and costs.

To build such a wireless communication network for an FEMS system, it is necessary to minimize a shaded area of a wireless communication signal under a poor factory channel environment. However, even if a wireless communication network is built to minimize a shaded area, there is a high possibility that an area in which a wireless communication channel environment becomes poor momentarily will occur in a factory environment where various variables exist. For example, the movement of workers, work tools, and work vehicles occurs frequently, resulting in changes in the wireless communication channel environment, which may lead to areas with poor channel environments.

Therefore, for a wireless network of an FEMS system to operate continuously, link adaptation is required to recover a damaged radio link in a poor wireless communication channel area caused by various variables and situations. To perform link adaptation, it is necessary to find a lost communication link in the wireless network of the FEMS system.

Therefore, to ensure more stable operations of a wireless network of an FEMS system, a method of more quickly searching for a lost communication link to which link adaptation is to be applied is needed.

### SUMMARY

Embodiments provide a communication link search method that finds a loss section of a communication link, which may occur due to various variables and situations, to provide continuous and stable wireless communication performance in a wireless communication network of a factory energy management system (FEMS).

Embodiments provide a communication link search method that performs data preprocessing using a matrix multiplication matrix based on each weight matrix from the perspective of a repeater and the perspective of a communication node, based on a communication quality matrix including a non-error conditional probability of a wireless communication signal of the communication node and a usage frequency matrix including a selection conditional probability of the repeater.

Embodiments provide, by performing data preprocessing that considers a factory energy management condition, a communication link search method that searches for a lost communication link in a wireless communication network and recovers the lost communication link by performing link adaptation on the lost communication link while systematically reflecting the requirements of a user and manager.

According to an aspect, there is provided a method of searching for a communication link, the method including, based on a repeater according to a communication path that is established between a communication node and the repeater in a wireless communication network, generating a communication quality matrix indicating a transmission quality of a wireless communication signal that is transmitted from the communication node, generating, based on the communication node, a usage frequency matrix indicating a frequency of use of whether the wireless communication signal that is transmitted from the communication node passes through the repeater, extracting a communication quality pattern and a usage frequency pattern in the wireless communication network by applying the communication quality matrix and the usage frequency matrix to a communication link application model based on machine learning, and searching for a point where loss of the communication link occurs in the wireless communication network by analyzing the communication quality pattern and the usage frequency pattern.

The generating of the communication quality matrix may include generating the communication quality matrix indicating the transmission quality of the wireless communication signal using a non-error conditional probability of the wireless communication signal that is transmitted from the communication node when an i-th repeater is included in the communication path.

The non-error conditional probability may be a numerical representation of the transmission quality using the number of packets including the i-th repeater in the communication path and the number of error packets among the number of packets including the i-th repeater in the communication path.

The generating of the usage frequency matrix may include generating the usage frequency matrix indicating the frequency of use using a selection conditional probability of whether an i-th repeater is included in the communication path when the wireless communication signal is transmitted from the communication node.

The selection conditional probability may be a numerical representation of whether the wireless communication signal passes through the repeater in a process of transmitting the wireless communication signal using a non-error conditional probability of the wireless communication signal that is transmitted from the communication node and a reference probability that the i-th repeater is included in the communication path, based on a non-error conditional probability of a communication node that is linked to a j-th control point.

The extracting of the communication quality pattern and the usage frequency pattern may include extracting the communication quality pattern related to a transmission rate of the communication node based on the repeater by applying the communication quality matrix to the communication link application model.

The extracting of the communication quality pattern and the usage frequency pattern may include extracting the usage frequency pattern related to communication connectivity of the repeater that is repeatedly used in the wireless communication network based on the communication node by applying the usage frequency matrix to the communication link application model.

The extracting of the communication quality pattern and the usage frequency pattern may include generating a weight matrix of the communication node, generating a weight matrix of the repeater, generating a first matrix multiplication matrix to perform data preprocessing using the weight matrix of the communication node, the communication quality matrix, and the usage frequency matrix, and generating a second matrix multiplication matrix to perform data preprocessing using the weight matrix of the repeater, the communication quality matrix, and the usage frequency matrix.

The extracting of the communication quality pattern and the usage frequency pattern may include determining a characteristic of the transmission quality of the wireless communication signal that is transmitted from the communication node on which data preprocessing is performed, by applying the first matrix multiplication matrix and the second matrix multiplication matrix to the communication link application mode, and extracting the communication quality pattern corresponding to the determined characteristic of the transmission quality.

The extracting of the communication quality pattern and the usage frequency pattern may include determining a characteristic of communication connectivity of the repeater on which data preprocessing is performed, by applying the first matrix multiplication matrix and the second matrix multiplication matrix to the communication link application model, and extracting the communication quality pattern corresponding to the determined characteristic of the communication connectivity.

The searching for the point where the loss of the communication link occurs may include, by analyzing the communication quality pattern and the usage frequency pattern, determining whether there is at least one point where the transmission quality of the wireless communication signal that is transmitted from the communication node is less than or equal in to a preset first threshold value or where a frequency of use of the repeater is greater than or equal to a preset second threshold value and searching for the point where the loss of the communication link occurs in the wireless communication network based on a determination result.

According to another aspect, there is provided a computing apparatus for performing a communication link search method, the computing apparatus including a processor, in which the processor is configured to, based on a repeater according to a communication path that is established between a communication node and the repeater in a wireless communication network, generate a communication quality matrix indicating a transmission quality of a wireless communication signal that is transmitted from the communication node, generate, based on the communication node, a usage frequency matrix indicating a frequency of use of whether the wireless communication signal that is transmitted from the communication node passes through the repeater, extract a communication quality pattern and a usage frequency pattern in the wireless communication network by applying the communication quality matrix and the usage frequency matrix to a communication link application model based on machine learning, and search for a point where loss of a communication link occurs in the wireless communication network by analyzing the communication quality pattern and the usage frequency pattern.

The processor may be configured to generate the communication quality matrix indicating the transmission quality of the wireless communication signal using a non-error conditional probability of the wireless communication signal that is transmitted from the communication node when an i-th repeater is included in the communication path.

The processor may be configured to generate the usage frequency matrix indicating the frequency of use using a selection conditional probability of whether an i-th repeater is included in the communication path when the wireless communication signal is transmitted from the communication node.

The processor may be configured to extract the communication quality pattern related to a transmission rate of the communication node based on the repeater by applying the communication quality matrix to the communication link application model.

The processor may be configured to extract the usage frequency pattern related to communication connectivity of the repeater that is repeatedly used in the wireless communication network based on the communication node by applying the usage frequency matrix to the communication link application model.

The processor may be configured to generate a weight matrix of the communication node, generate a weight matrix of the repeater, generate a first matrix multiplication matrix to perform data preprocessing using the weight matrix of the communication node, the communication quality matrix, and the usage frequency matrix, and generate a second matrix multiplication matrix to perform data preprocessing using the weight matrix of the repeater, the communication quality matrix, and the usage frequency matrix.

The processor may be configured to determine a characteristic of the transmission quality of the wireless communication signal that is transmitted from the communication node on which data preprocessing is performed, by applying the first matrix multiplication matrix and the second matrix multiplication matrix to the communication link application model, extract the communication quality pattern corresponding to the determined characteristic of the transmission quality, determine a characteristic of communication connectivity of the repeater on which data preprocessing is performed, by applying the first matrix multiplication matrix and the second matrix multiplication matrix to the communication link application model, and extract the communication quality pattern corresponding to the determined characteristic of the communication connectivity.

The processor may be configured to, by analyzing the communication quality pattern and the usage frequency pattern, determine whether there is at least one point where the transmission quality of the wireless communication signal that is transmitted from the communication node is less than or equal to a preset first threshold value or where a frequency of use of the repeater is greater than or equal to a preset second threshold value and search for the point where the loss of the communication link occurs in the wireless communication network based on a determination result.

According to still another aspect, there is a system for managing energy, the system including at least one communication node configured to transmit a wireless communication signal in a wireless communication network by interoperating with a control point, at least one repeater configured to receive the wireless communication signal that is transmitted from the at least one communication node or configured to retransmit the transmitted wireless communication signal according to a communication path that is established in the wireless communication signal, a gateway configured to receive the wireless communication signal from the at least one communication node and the at least one repeater, and a computing apparatus configured to search for a point where loss of a communication link occurs by identifying a connection state of the communication link among the at least one communication node, the at least one repeater, and the gateway, in which the computing apparatus is configured to, based on the at least one repeater according to the communication path that is established between the least one communication node and the at least one repeater in the wireless communication network, generate a communication quality matrix indicating a transmission quality of the wireless communication signal that is transmitted from the least one communication node, generate, based on the least one communication node, a usage frequency matrix indicating a frequency of use of whether the wireless communication signal that is transmitted from the least one communication node passes through the at least one repeater, extract a communication quality pattern and a usage frequency pattern in the wireless communication network by applying the communication quality matrix and the usage frequency matrix to a communication link application model based on machine learning, and search for the point where the loss of the communication link occurs in the wireless communication network by analyzing the communication quality pattern and the usage frequency pattern.

Additional aspects of embodiments will be set forth in part in the description which follows and, in part, will be apparent from the description, or may be learned by practice of the disclosure.

According to embodiments, a loss section of a communication link that may occur due to various environmental variables and situations may be found to provide continuous and stable wireless communication performance in a wireless communication network of a factory energy management system (FEMS).

According to embodiments, data preprocessing may be performed using a matrix multiplication matrix based on each weight matrix from the perspective of a repeater and the perspective of a communication node, based on a communication quality matrix including a non-error conditional probability of a wireless communication signal of the communication node and a usage frequency matrix including a selection conditional probability of the repeater.

According to embodiments, data preprocessing that considers a factory energy management condition may be performed to systematically reflect the requirements of a user and manager and search for a lost communication link in a wireless communication network.

According to embodiments, by searching for a lost communication link in a wireless communication network while systematically reflecting the requirements of a user and manager, link adaptation may be performed on the found communication link to maintain a communication state of a wireless communication network of an FEMS at an appropriate level.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an energy management system including a computing apparatus, according to an embodiment;

FIG. 2A and FIG. 2B is a diagram illustrating a process of searching for a point where loss of a communication link occurs and performing link adaptation, according to an embodiment;

FIG. 3 is a diagram illustrating a process of generating a communication quality matrix and a usage frequency matrix, according to an embodiment;

FIG. 4 is a diagram illustrating a process of applying a communication quality matrix and a usage frequency matrix to a communication link application model based on machine learning, according to an embodiment;

FIG. 5 is a diagram illustrating a process of applying a weight matrix of a repeater and a weight matrix of a communication node to a communication link application model, according to an embodiment;

FIG. 6 is a diagram illustrating a process of forming a matrix multiplication matrix using a weighted diagonal matrix from the perspective of a repeater, according to an embodiment;

FIG. 7 is a diagram illustrating a process of forming a matrix multiplication matrix using a weighted diagonal matrix from the perspective of a communication node, according to an embodiment;

FIG. 8 is a diagram illustrating a process of performing an application of a weight for data preprocessing, according to an embodiment;

FIG. 9 is a flowchart illustrating a communication link search method according to an embodiment;

FIG. 10 is a diagram illustrating a communication link that may be set between pieces of communication terminal equipment including a communication node, a repeater, and a gateway, according to an embodiment;

FIG. 11 is a diagram illustrating an outputter of a computing apparatus according to a communication link, according to an embodiment; and

FIG. 12 is a block diagram illustrating an example of a configuration of a computing apparatus that searches for a point where loss of a communication link occurs, according to an embodiment.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In the descriptions of the embodiments referring to the accompanying drawings, like reference numerals refer to like elements and any repeated description related thereto will be omitted. In the description of embodiments, detailed description of well-known related structures or functions will be omitted when it is deemed that such description will cause ambiguous interpretation of the present disclosure.

In addition, terms such as first, second, A, B, (a), (b), and the like may be used to describe components of the embodiments. Each of these terms is not used to define an essence, order, or sequence of corresponding components, but used merely to distinguish the corresponding components from other components. It is to be understood that if a component is described as being “connected,” “coupled” or “joined” to another component, the former may be directly “connected,” “coupled,” and “joined” to the latter or “connected”, “coupled”, and “joined” to the latter via another component.

Components included in an embodiment and components having a common function are described using the same names in other embodiments. Unless stated otherwise, the description of an embodiment may be applicable to other embodiments, and a repeated description related thereto is omitted.

A communication link search method described herein may be a method of determining a point where loss of a communication link occurs by identifying a connection state of wireless communication in a wireless communication network used in a factory energy management system (FEMS). Furthermore, the communication link search method may provide more stable wireless communication performance by performing link adaptation so that the connection state according to the loss of the communication link is maintained at an appropriate level.

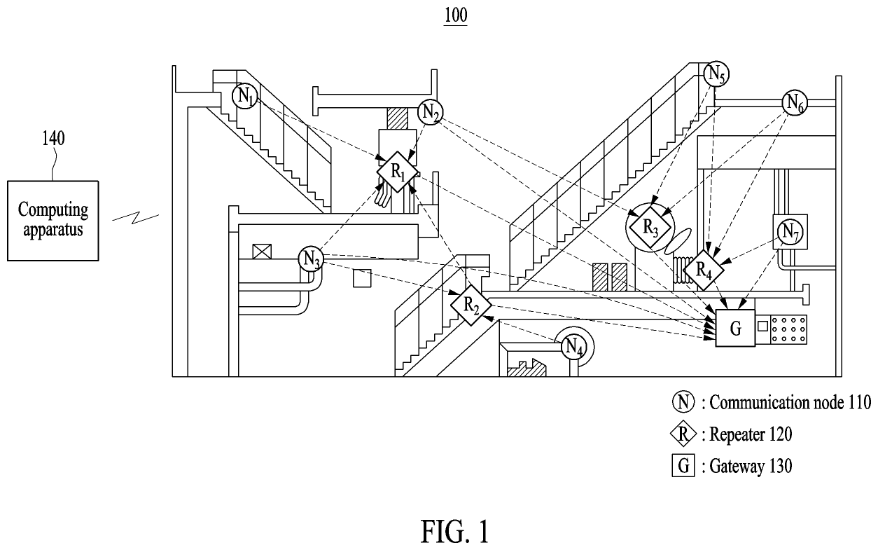

FIG. 1 is a diagram illustrating an energy management system including a computing apparatus, according to an embodiment.

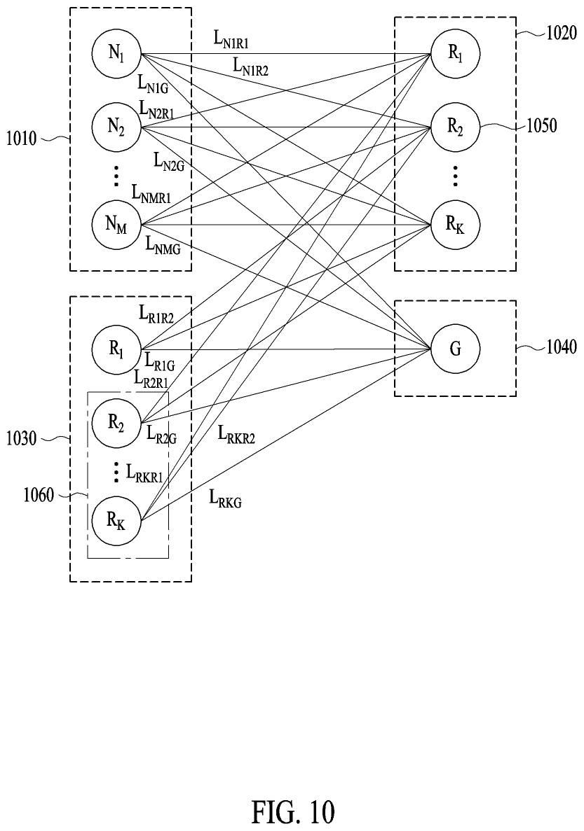

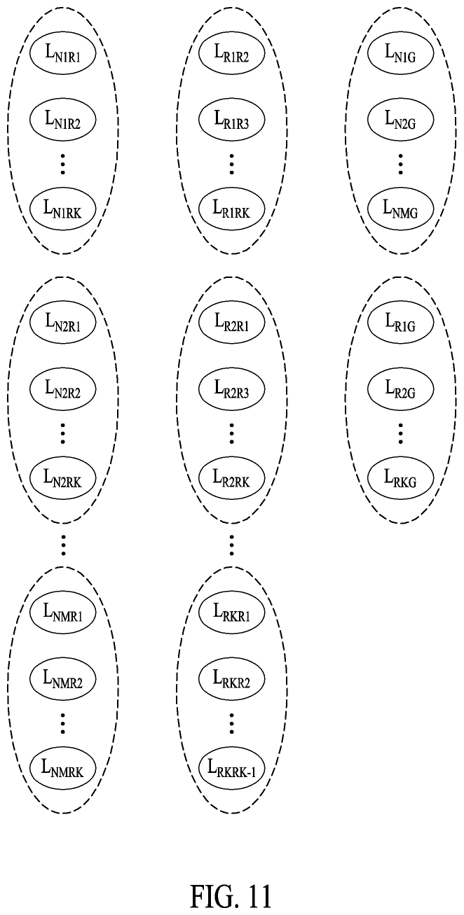

Referring to FIG. 1, an energy management system 100 may transmit and receive data, which is observed at an energy control point in a factory, using a wireless communication network of a factory energy management system (FEMS) that may be built in the factory. The energy management system 100 may include a communication node 110, a repeater 120, and a gateway 130 to perform wireless communication in the wireless communication network of the FEMS. The communication node 110, the repeater 120, and the gateway 130 may be provided in plurality according to the building situation in the factory. The communication node 110, the repeater 120, and the gateway 130 may be pieces of communication terminal equipment that transmit and receive a wireless communication signal, and a communication link may be formed between the pieces of communication terminal equipment including the communication node 110, the repeater 120, the gateway 130, and the like that transmit and receive a wireless communication signal. Ultimately, the communication link may be formed between the pieces of communication terminal equipment, such as between the communication node 110 and the repeater 120, between different repeaters, rather than between predetermined repeaters, i.e., between a repeater 102 and the repeater 120, between the communication node 110 and the gateway 130, and between the repeater 120 and the gateway 130. This is described in more detail below with reference to FIGS. 10 and 11.

The communication node 110 may function as a wireless communication terminal that transmits and receives FEMS observation data and FEMS control data to and from the gateway 130 by interoperating with a measuring instrument, a sensor, or an actuator, which may be installed on the energy control point in the factory.

The repeater 120 may function to support communication in a shaded area that is generated in the factory in the process of performing wireless communication between the communication node 110 and the gateway 130. For example, a factory on which the energy management system 100 is installed may have a shaded area in a wireless communication channel in the factory due to metal objects, such as metal scaffolding, metal stairs, and metal supports, as well as vibrations and dust generated by these metal objects. The repeater 120 may be disposed to overcome poor or degraded wireless communication in the shaded area formed in the factory.

The communication node 110 may communicate directly with the gateway 130 according to the wireless communication environment in the factory. Furthermore, the communication node 110 may communicate indirectly with the gateway 130 through one repeater or one or more repeaters.

When transmitting a wireless communication signal that is transmitted from the communication node 110 to the gateway 130, the repeater 120 may include an identification (ID) for identifying the repeater 120 in a packet of the wireless communication signal and may transmit the ID. This may be used to manage a communication path for the wireless communication signal of the communication node 110 or to identify a communication state of the repeater 120 according to whether the communication node 110 transmits the wireless communication signal.

The gateway 130 may perform wireless communication through the communication node 110 and the repeater 120 and may collect FEMS observation data or may transmit FEMS control data to the actuator. The gateway 130 may identify whether there is a packet error of the wireless communication signal that is transmitted through the communication node 110 and the repeater 120 and may request retransmission to the communication node 110 and the repeater 120.

The energy management system 100 may include a computing apparatus 140, and the computing apparatus 140 may monitor operations performed among the communication node 110, the repeater 120, and the gateway 130 according to wireless communication performed in the wireless communication network of the FEMS. The computing apparatus 140 may search for a lost communication link in the wireless communication network of the FEMS in the process of transmitting and receiving the wireless communication signal. The computing apparatus 140 may recover the lost communication link by performing link adaptation on the communication link that is found to be lost.

To this end, in the wireless communication network of the FEMS, the computing apparatus 140 may generate a communication quality matrix including a non-error conditional probability between the communication node 110 and the repeater 120 and a usage frequency matrix including a selection conditional probability of the repeater 120. The computing apparatus 140 may generate a matrix multiplication matrix from the perspective of the communication node 110 and a matrix multiplication matrix from the perspective of the repeater 120 to perform data preprocessing based on the communication quality matrix and the usage frequency matrix. The computing apparatus 140 may search for and recover the lost communication link in the wireless communication network of the FEMS using the communication quality matrix, the usage frequency matrix, and each matrix multiplication matrix.

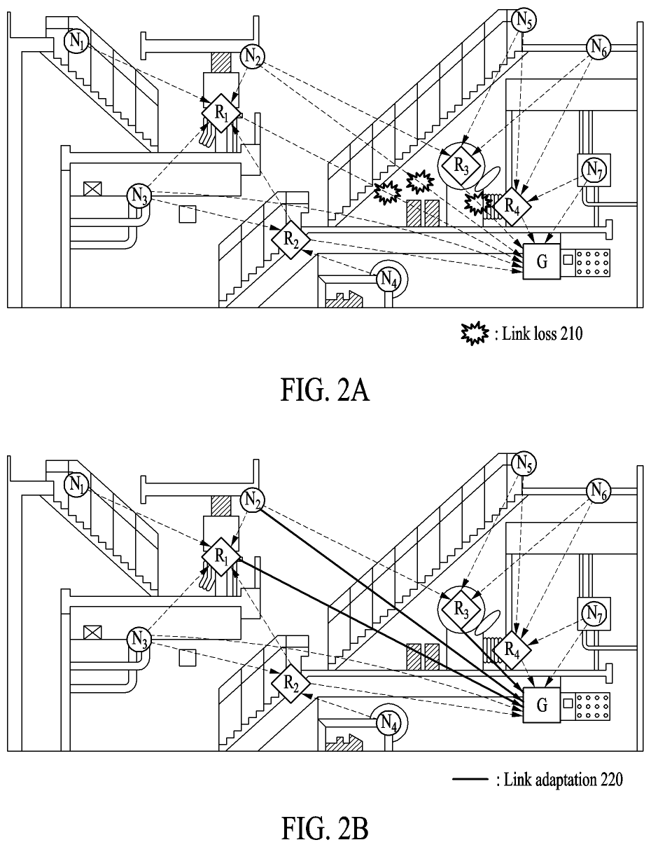

FIG. 2A and FIG. 2B is a diagram illustrating a process of searching for a point where loss of a communication link occurs and performing link adaptation, according to an embodiment.

Referring to FIG. 2A and FIG. 2B, the present disclosure may represent the need for loss recovery through link adaptation in a wireless communication network of an FEMS in a factory.

FIG. 2A illustrates that loss of a communication link occurs in a predetermined area of a wireless communication network due to variables according to a poor wireless communication environment in the wireless communication network. The computing apparatus 140 may identify a connection state of wireless communication in the wireless communication network by applying, to a communication link application model based on machine learning, at least one of a communication quality matrix, a usage frequency matrix, a matrix multiplication matrix from the perspective of the communication node 110, and a matrix multiplication matrix from the perspective of the repeater 120. The computing apparatus 140 may determine the point where the loss of the communication link occurs according to the connection state of wireless communication. For example, the point where the loss of the communication link occurs may be a communication point connecting repeater \textcircled{1} to the gateway 130, a communication point connecting communication node \textcircled{2} to the gateway 130, or a communication point connecting repeater \textcircled{3} to the gateway 130.

Here, the data transmission quality of a wireless communication signal passing through the communication point where the loss of the communication link occurs may be lower than the data transmission quality of a wireless communication signal that is transmitted and received to and from other communication points. This may indicate a high possibility of degradation of pieces of data at an energy control point, which should be included in the wireless communication signal passing through the communication point where the loss of the communication link occurs.

FIG. 2B illustrates that link adaptation is performed so that the connection state according to the loss of the communication link is maintained at an appropriate level. When the communication point where the loss of the communication link occurs is searched for, the computing apparatus 140 may identify the communication node 110, the repeater 120, and the gateway 130, which perform a connection of a corresponding communication point. That is, the computing apparatus 140 may extract the communication node 110 and the repeater 120, which generate, transmit, and receive the wireless communication signal by passing through the communication point where the loss of the communication link occurs. The computing apparatus 140 may recover or overcome the loss of the communication link with respect to the corresponding communication point by performing link adaptation on the communication node 110 and the repeater 120, which are extracted.

Here, the computing apparatus 140 may consider the following prerequisites for link adaptation in the wireless communication network of the FEMS proposed herein. The computing apparatus 140 may support performing link adaptation on the communication node 110 and the repeater 120 in response to satisfying the following prerequisites.

### (a) Prerequisite 1

In the present disclosure, the gateway 130 may calculate a packet error probability by determining whether a packet included in the wireless communication signal is in error. Specifically, the computing apparatus 140 may perform a function of determining whether a first packet included in the wireless communication signal is in error. The function of determining whether there is an error may be a function that is generally supported in wireless communication technology through a frame check sum (FCS) based on a cyclic redundancy check (CRC). The calculation of the packet error probability through the determination of whether the packet is in error may be calculated by dividing the number of packets in which an error occurs during a predetermined period of time by the number of packets received during the same period of time.

The present disclosure may support performing link adaptation in general wireless communication technology by considering the limit conditions regarding the calculation of the packet error probability.

### (b) Prerequisite 2

The present disclosure may store an address or index of the communication node 110, which transmits a wireless communication signal, in wireless communication data that is transmitted to the gateway 130. Furthermore, the present disclosure may store, in the wireless communication data, an address or index of the repeater 120 through which the wireless communication signal passes. Through this, the gateway 130 may identify a communication path through which the wireless communication signal passes by identifying the address or index of the communication node 110, which transmits the wireless communication signal through the wireless communication data that is received from the communication node 110 or the repeater 120, and the address or index of the repeater 120 through which the wireless communication signal passes.

### (c) Prerequisite 3

The present disclosure may support a link adaptation method such as adaptive coding and modulation (ACM). For example, the communication node 110, the repeater 120, and the gateway 130, which form the wireless communication network of the FEMS, may be general technologies used in a wireless fidelity (Wi-Fi) wireless communication method and may include a function of supporting link adaptation such as ACM.

### (d) Prerequisite 4

In the present disclosure, the gateway 130 may transmit whether and how much link adaptation is used to the repeater 120 and the communication node 110 through a downlink. For example, the gateway 130 may transmit whether link adaptation is used and information thereof to the repeater 120 and the communication node 110 through a downlink using a wireless communication method capable of bidirectional communication.

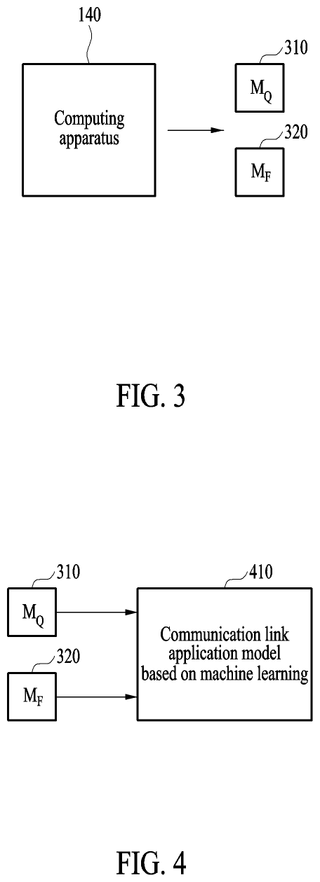

FIG. 3 is a diagram illustrating a process of generating a communication quality matrix and a usage frequency matrix, according to an embodiment.

Referring to FIG. 3, to perform an application of link adaptation of a wireless communication network of an FEMS, the present disclosure may be in a state in which a wireless communication method supporting the four functions described with reference to FIG. 2A and FIG. 2B is applied or in a state in which the four functions are implemented in a wireless communication method to be applied. That is, the present disclosure may propose performing link adaptation of the wireless communication network under the assumption that the wireless communication method to be applied supports the four functions described with reference to FIG. 2A and FIG. 2B.

The present disclosure may derive a process of performing link adaptation of the wireless communication network based on a non-error conditional probability and a selection conditional probability. The present disclosure may consider the following Equations. Equations 1 to 3 below may be equations related to the law of total probability related to a conditional probability before considering the conditional probability to be used in the present disclosure. Here, in probability theory, the theory of total probability is a law that allows a sample space to be divided into non-overlapping events to calculate the probability, and N events in which the sample spaces do not overlap may be expressed as Equation 1 below.

$$P ( A ) = {\sum }_{k = 1}^{N} P ( A \vert {B}_{k} ) = P ( A \vert {B}_{1} ) + P ( A \vert {B}_{2} ) + … + P ( A \vert {B}_{N} ) \qquad [ Equation 1 ]$$

In probability theory, the conditional probability may refer to the probability that another event occurs under the condition that an event occurred, which may be expressed as Equation 2 below according to Bayes' Theorem.

$$P ( {A}_{i} \vert {B}_{j} ) = \frac{P ( {B}_{j} \vert {A}_{i} ) P ( {A}_{i} )}{P ( {B}_{j} )} \qquad [ Equation 2 ]$$

Equation 2 may be applied to Equation 1 representing the law of total probability, which may be expressed in an expanded form as shown in Equation 3 below.

$$P ( {A}_{i} \vert {B}_{j} ) = \frac{P ( {B}_{j} \vert {A}_{i} ) P ( {A}_{i} )}{P ( {B}_{j} )} = \frac{P ( {B}_{j} \vert {A}_{i} ) P ( {A}_{i} )}{{\sum }_{k = 1}^{N} P ( {B}_{j} \vert {A}_{k} )} = \frac{P ( {B}_{j} \vert {A}_{i} ) P ( {A}_{i} )}{P ( {B}_{j} \vert {A}_{1} ) + P ( {B}_{j} \vert {A}_{2} ) + … + P ( {B}_{j} \vert {A}_{N} )} \qquad [ Equation 3 ]$$

The present disclosure may define symbols to represent the non-error conditional probability and the selection conditional probability according to the components of wireless communication, as shown in Table 1 below, with reference to Equations 1 to 3 described above.

TABLE 1

| Symbol | Description |
|---|---|
| Rᵢ | An i-th repeater. i = 0, 1, 2, . . . , K. K is the |
| | number of repeaters. R₀ is a |
| | communication path that does not pass |
| | through a repeater. |
| Nⱼ | A communication node linked to a j-th |
| | control point (a sensor, a measuring |
| | instrument, an actuator, etc.). j = 1, 2, . . . , |
| | M. M is the number of control points |
| | linked to a communication node. |
| P(Nⱼ) | A packet non-error probability of a |
| | communication node linked to an j-th control |
| | point. |
| P(Rᵢ) | A probability that an i-th repeater is included |
| | in a communication path. |
| Pₑ(Nⱼ\|Rᵢ) | A packet error probability for a signal that is |
| | transmitted from a communication node Nⱼ |
| | when an i-th repeater is included in a |
| | communication path. |
| P(Nⱼ\|Rᵢ) | A packet non-error probability for a wireless |
| | communication signal that is transmitted |
| | from a communication node Nⱼ when an i-th |
| | repeater is included in a communication path. |
| | P(Nⱼ\|Rᵢ) = 1 − Pₑ(Nⱼ\|Rᵢ) |
| P(Rᵢ\|Nⱼ) | A probability that an i-th repeater is included |
| | in a communication path when a wireless |
| | signal is transmitted from a communication |
| | node Nⱼ. |

The present disclosure may use P(Nⱼ|Rᵢ) and P(Rᵢ|Nⱼ) as probability metrics to be used as key measuring indicators in link adaptation of the wireless communication network.

The probability metric P(Nⱼ|Rᵢ) may be a packet non-error probability for a wireless communication signal that is transmitted from a communication node Nⱼ when an i-th repeater is included. The probability metric P(Nⱼ|Rᵢ) is an indicator associated with the transmission quality (e.g., a quality of service (QoS)) for the wireless communication network of the FEMS and may identify whether there is a shaded area in the wireless communication network, whether link loss occurs, and the degree of loss.

P(Nⱼ|Rᵢ) may be used by a gateway to identify a communication path of the wireless communication signal that is transmitted from the communication node Nⱼ and whether a packet error occurs, which may be expressed as shown in Equation 4 below.

$$[ Equation 4 ]$$

$$P ( {N}_{j} \vert {R}_{i} ) = 1 - {P}_{e} ( {N}_{j} \vert {R}_{i} ) = 1 - \frac{\begin{matrix}the number of error packets among packets \\ including repeater {R}_{i} in communcation path\end{matrix}}{\begin{matrix}the number of packets including repeater \\ {R}_{i} in communication path\end{matrix}}$$

Referring to Equation 4, 1 denotes all wireless communication signals received in the communication path on the wireless communication network, and Pₑ(Nⱼ|Rᵢ) denotes a packet error probability for the wireless communication signal that is transmitted from the communication node Nⱼ when the i-th repeater is included in the communication path and may be an inverse probability metric of the probability metric P(Nⱼ|Rᵢ).

More specifically, in Equation 3,

$${\sum }_{k = 0}^{K} P ( {N}_{j} \vert {R}_{k} )$$

denotes the sum of the packet non-error probabilities of a j-th communication node that passes through a repeater Rₖ, k denotes 0, 1, . . . , K, and R₀ may correspond to a path in which a communication node and a gateway are directly connected without passing through a repeater. Based on Equation 3, the present disclosure may derive Equation 4 calculating the packet non-error probability of a communication node.

In addition, a probability P(Rᵢ) forming Equation 3 denotes the probability that a repeater Rᵢ is included in the communication path in the configuration performance measurement stage of an n-th repeater, and the present disclosure may derive Equation 5 below from the configuration of Equation 3.

$$P ( {R}_{i} ) = \frac{\begin{matrix}number of times relayed through repeater \\ {R}_{i} on communication path identified by \\ gateway\end{matrix}}{\begin{matrix}number of times relayed through repeater \\ on communication path identified by \\ gateway\end{matrix}} \qquad [ Equation 5 ]$$

In Equation 5, the denominator denotes the number of times a wireless communication signal is relayed through a repeater, and when the wireless communication signal is relayed through any one repeater on the communication path, this may be considered as one time. In addition, in the case of a packet of a wireless communication signal that passes through a plurality of repeaters on the communication path, the present disclosure may indicate, as the number of times relayed, the number of addresses or indices of repeaters stored in the packet of the received wireless communication signal. Accordingly, the number of times relayed through the repeater on the communication path that is identified by the gateway may be greater than or equal to the number of packets received by the gateway.

The probability metric P(Rᵢ|Nⱼ) may be the probability that the i-th repeater is included in the communication path when the wireless communication signal is transmitted from the communication node Nⱼ The probability metric P(Rᵢ|Nⱼ) may identify the position of a corresponding repeater corresponding to a shaded area or link occurrence area of the wireless communication network by identifying whether the i-th repeater is included in the communication path that starts from the communication node Nⱼ.

The probability metric P(Rᵢ|Nⱼ) may derive Equation 6 below based on the equation of the conditional probability expressed in Equation 3.

$$P ( {R}_{i} \vert {N}_{j} ) = \frac{P ( {N}_{j} \vert {R}_{i} ) P ( {R}_{i} )}{P ( {N}_{j} )} = \frac{P ( {N}_{j} \vert {R}_{i} ) P ( {R}_{i} )}{{\sum }_{k = 0}^{K} P ( {N}_{j} \vert {R}_{k} )} = \frac{P ( {N}_{j} \vert {R}_{i} ) P ( {R}_{i} )}{P ( {N}_{j} \vert {R}_{0} ) + P ( {N}_{j} \vert {R}_{1} ) + ⋯ + P ( {N}_{j} \vert {R}_{K} )} \qquad [ Equation 6 ]$$

The link adaptation of the wireless communication network proposed herein may be centered on a method of finding a communication area in which loss of a communication link occurs. To this end, the present disclosure may use the probability metrics P(Nⱼ|Rᵢ) and P(Rᵢ|Nⱼ) as metrics for finding a point where the loss of the communication link occurs in the wireless communication network.

When the i-th repeater Rᵢ is included in the communication path, the packet non-error probability P(Nⱼ|Rᵢ) of the wireless communication signal that is transmitted from the communication node Nⱼ may indicate the transmission rate of the communication node Nⱼ when the repeater Rᵢ is included in the communication path. That is, the high probability P(Nⱼ|Rᵢ) may indicate that the transmission rate of the wireless communication signal of the communication node Nⱼ that passes through the repeater Rᵢ is high.

When the wireless communication signal is transmitted from the communication node Nⱼ, the probability P(Rᵢ|Nⱼ) that the i-th repeater Rᵢ is included in the communication path may indicate the frequency with which the wireless communication signal that is transmitted from the communication node Nⱼ passes through the repeater Rᵢ. The high probability P(Rᵢ|Nⱼ) may indicate that the communication node Nⱼ uses the repeater Rᵢ a lot.

Ultimately, the probability metric P(Nⱼ|Rᵢ) may refer to a metric regarding the transmission quality of the communication node Nⱼ and the repeater Rᵢ. The probability metric P(Rᵢ|Nⱼ) may refer to a metric regarding the frequency of use of the communication node Nⱼ and the repeater Rᵢ.

Accordingly, the present disclosure may use the probability metrics P(Nⱼ|Rᵢ) and P(Rᵢ|Nⱼ) Since the probability metrics R(Nⱼ|Rᵢ) and R(Rᵢ|Nⱼ) are metrics regarding the communication node Nⱼ and the repeater Rᵢ, respectively, which may be expanded and expressed as matrices regarding the communication node Nⱼ (j=1, 2, . . . , M) and the repeater Rᵢ (i=0, 1, 2, . . . , K), as shown in Equations 7 and 8 below.

$${M}_{Q} = [ \begin{matrix}P ( {N}_{1} \vert {R}_{0} ) & P ( {N}_{1} \vert {R}_{1} ) & ⋯ & P ( {N}_{1} \vert {R}_{K} ) \\ P ( {N}_{2} \vert {R}_{0} ) & P ( {N}_{2} \vert {R}_{1} ) & ⋯ & P ( {N}_{2} \vert {R}_{K} ) \\ ⋮ & ⋮ & ⋱ & ⋮ \\ P ( {N}_{M} \vert {R}_{0} ) & P ( {N}_{M} \vert {R}_{1} ) & ⋯ & P ( {N}_{M} \vert {R}_{K} )\end{matrix} ] \qquad [ Equation 7 ]$$

In Equation 7, a communication quality matrix M_{Q} 310 is an extension of the probability metric P(Nⱼ|Rᵢ), may be related to the communication quality (e.g., QoS), and may have a size of M*(K+1). Accordingly, each element P(Nⱼ|Rᵢ) of the communication quality matrix M_{Q} 310 represented by Equation 7 may represent the transmission rate, i.e., the communication quality, with respect to the communication node Nⱼ and the repeater Rᵢ.

$${M}_{F} = [ \begin{matrix}P ( {R}_{0} \vert {N}_{1} ) & P ( {R}_{0} \vert {N}_{2} ) & ⋯ & P ( {R}_{0} \vert {N}_{M} ) \\ P ( {R}_{1} \vert {N}_{1} ) & P ( {R}_{1} \vert {N}_{2} ) & ⋯ & P ( {R}_{1} \vert {N}_{M} ) \\ ⋮ & ⋮ & ⋱ & ⋮ \\ P ( {R}_{K} \vert {N}_{1} ) & P ( {R}_{K} \vert {N}_{2} ) & ⋯ & P ( {R}_{K} \vert {N}_{M} )\end{matrix} ] \qquad [ Equation 8 ]$$

In Equation 8, a usage frequency matrix M_{F} 320 is an extension of the probability metric R(Rᵢ|Nⱼ), may be related to the frequency of use, and may have a size of (K+1)*M. Accordingly, each element R(Rᵢ|Nⱼ) of the usage frequency matrix M_{F} 320 represented by Equation 8 may represent the frequency of use, i.e., communication connectivity, with respect to the communication node Nⱼ and the repeater Rᵢ.

The present disclosure may identify the communication quality state and communication connectivity of the wireless communication network through the communication quality matrix M_{Q} 310 and the usage frequency matrix M_{F} 320. Ultimately, the present disclosure may find whether link loss occurs and an occurrence area in the wireless communication network by monitoring and analyzing the patterns of the communication quality matrix M_{Q} 310 and the usage frequency matrix M_{F} 320. That is, the present disclosure may find the pattern of the communication quality matrix M_{Q} 310 and the pattern of the usage frequency matrix M_{F} 320 associated with the link loss occurrence area to find an area where link loss occurs in the wireless communication network of the FEMS.

FIG. 4 is a diagram illustrating a process of applying a communication quality matrix and a usage frequency matrix to a communication link application model based on machine learning, according to an embodiment.

Referring to FIG. 4, the present disclosure may apply the communication quality matrix M_{Q} 310 and the usage frequency matrix M_{F} 320 to a communication link application model based on machine learning 410 as input values.

The computing apparatus 140 may utilize the communication link application model based on machine learning 410 to recognize patterns of the communication quality matrix M_{Q} 310 and the usage frequency matrix M_{F} 320. Through the communication link application model based on machine learning 410, the computing apparatus 140 may find whether a communication link occurs and an occurrence area in a wireless communication network. For example, the communication link application model based on machine learning 410 may be implemented in various forms and methods, such as supervised learning, unsupervised learning, reinforcement learning, and support vector machine (SVM). In addition, any method capable of searching for whether a link occurs and an occurrence area in a wireless communication network of an FEMS may also be included.

The computing apparatus 140 may train the pattern of the communication quality matrix M_{Q} 310 and the pattern of the usage frequency matrix M_{F} 320 associated with an area where link loss occurs through the communication link application model based on machine learning 410. For example, the communication link application model based on machine learning 410 may train a predetermined pattern of the communication quality by analyzing a signal interval, a frequency pattern, signal strength, or the like through the communication quality matrix M_{Q} 310 that is input. In another example, the communication link application model based on machine learning 410 may train the number of times each repeater periodically or intermittently transmits and receives a wireless communication signal through the usage frequency matrix M_{F} 320 that is input.

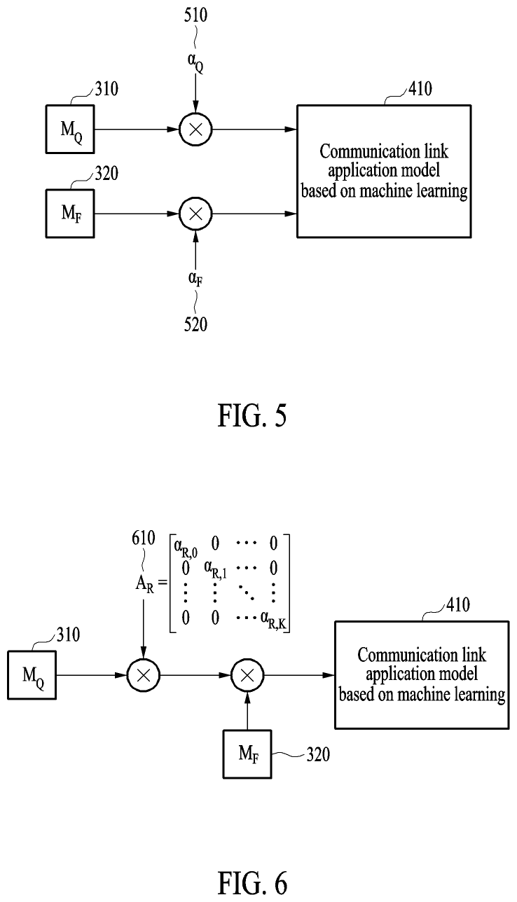

FIG. 5 is a diagram illustrating a process of applying a weight matrix of a repeater and a weight matrix of a communication node to a communication link application model, according to an embodiment.

Referring to FIG. 5, the computing apparatus 140 may apply a scalar weight α_{Q} 510 and a scalar weight α_{F} 520 to the communication quality matrix M_{Q} 310 and the usage frequency matrix M_{F} 320, respectively. More specifically, the present disclosure may generate the scalar weight α_{Q} 510 and the scalar weight α_{F} 520 to reflect the requirements (intentions) of a user or manager related to a wireless channel environment in a factory. The computing apparatus 140 may perform training using the communication link application model based on machine learning 410 by applying the scalar weight α_{Q} 510 and the scalar weight α_{F} 520 to the communication quality matrix M_{Q} 310 and the usage frequency matrix M_{F} 320, respectively.

The present disclosure may set a schematic characteristic or goal with respect to link adaptation of the wireless communication network according to the requirements of the user or manager through the scalar weight α_{Q} 510 and the scalar weight α_{F} 520.

FIG. 6 is a diagram illustrating a process of forming a matrix multiplication matrix using a weighted diagonal matrix from the perspective of a repeater, according to an embodiment.

Referring to FIG. 6, the computing apparatus 140 may perform link adaptation of a communication channel based on data preprocessing by setting a weight from the perspective of the repeater. The present disclosure may generate a matrix multiplication matrix M_{Q}A_{R} M_{F}, which is the weight from the perspective of the repeater, to set a characteristic or goal for more detailed and systematic adaptation of the wireless communication network for each of a plurality of repeaters.

Data preprocessing by setting an input data weight from the perspective of the repeater may be selected and used by a user or manager of a wireless network based on factors, such as an environment, a utility usage condition, and a process priority of a factory where the wireless communication network is built.

To generate the matrix multiplication matrix from the perspective of the repeater, the present disclosure may set a weighted diagonal matrix 610 having a size of (K+1)*(K+1) with respect to the repeater, as shown in Equation 9 below.

$${A}_{R} = [ \begin{matrix}{α}_{R , 0} & 0 & ⋯ & 0 \\ 0 & {α}_{R , 1} & ⋯ & 0 \\ ⋮ & ⋮ & ⋱ & ⋮ \\ 0 & 0 & ⋯ & {α}_{R , k}\end{matrix} ] \qquad [ Equation 9 ]$$

Referring to Equation 9, Referring to Equation 9, the present invention may form a matrix structure so that matrix multiplication is possible by sequentially positioning the weighted diagonal matrix from the perspective of the repeater in the middle between the communication quality matrix M_{Q} 310 and the usage frequency matrix M_{F} 320. This may calculate the matrix multiplication, as shown in Equation 10 below.

$${M}_{Q} {A}_{R} {M}_{F} = [ \begin{matrix}P ( {N}_{1} \vert {R}_{0} ) & P ( {N}_{1} \vert {R}_{1} ) & ⋯ & P ( {N}_{1} \vert {R}_{K} ) \\ P ( {N}_{2} \vert {R}_{0} ) & P ( {N}_{2} \vert {R}_{1} ) & ⋯ & P ( {N}_{2} \vert {R}_{K} ) \\ ⋮ & ⋮ & ⋱ & ⋮ \\ P ( {N}_{M} \vert {R}_{0} ) & P ( {N}_{M} \vert {R}_{1} ) & ⋯ & P ( {N}_{M} \vert {R}_{K} )\end{matrix} ] [ \begin{matrix}{α}_{R , 0} & 0 & ⋯ & 0 \\ 0 & {α}_{R , 1} & ⋯ & 0 \\ ⋮ & ⋮ & ⋱ & ⋮ \\ 0 & 0 & ⋯ & {α}_{R , k}\end{matrix} ] [ \begin{matrix}P ( {R}_{0} \vert {N}_{1} ) & P ( {R}_{0} \vert {N}_{2} ) & ⋯ & P ( {R}_{0} \vert {N}_{M} ) \\ P ( {R}_{1} \vert {N}_{1} ) & P ( {R}_{1} \vert {N}_{2} ) & ⋯ & P ( {R}_{1} \vert {N}_{M} ) \\ ⋮ & ⋮ & ⋱ & ⋮ \\ P ( {R}_{K} \vert {N}_{1} ) & P ( {R}_{K} \vert {N}_{2} ) & ⋯ & P ( {R}_{K} \vert {N}_{M} )\end{matrix} ] \qquad [ Equation 10 ]$$

In addition, the matrix multiplication matrix M_{Q} A_{R}M_{F} from the perspective of the repeater in Equation 10 may be solved as shown in Equation 11 below.

$${M}_{Q} {A}_{R} {M}_{F} = [ \begin{matrix}{\sum }_{i = 0}^{K} {α}_{R , i} P ( {N}_{1} \vert {R}_{i} ) P ( {R}_{i} \vert {N}_{1} ) & {\sum }_{i = 0}^{K} {α}_{R , i} P ( {N}_{1} \vert {R}_{i} ) P ( {R}_{i} \vert {N}_{2} ) & ⋯ & {\sum }_{i = 0}^{K} {α}_{R , i} P ( {N}_{1} \vert {R}_{i} ) P ( {R}_{i} \vert {N}_{M} ) \\ {\sum }_{i = 0}^{K} {α}_{R , i} P ( {N}_{2} \vert {R}_{i} ) P ( {R}_{i} \vert {N}_{1} ) & {\sum }_{i = 0}^{K} {α}_{R , i} P ( {N}_{2} \vert {R}_{i} ) P ( {R}_{i} \vert {N}_{2} ) & ⋯ & {\sum }_{i = 0}^{K} {α}_{R , i} P ( {N}_{2} \vert {R}_{i} ) P ( {R}_{i} \vert {N}_{M} ) \\ ⋮ & ⋮ & ⋱ & ⋮ \\ {\sum }_{i = 0}^{K} {α}_{R , i} P ( {N}_{M} \vert {R}_{i} ) P ( {R}_{i} \vert {N}_{1} ) & {\sum }_{i = 0}^{K} {α}_{R , i} P ( {N}_{M} \vert {R}_{i} ) P ( {R}_{i} \vert {N}_{2} ) & ⋯ & {\sum }_{i = 0}^{K} {α}_{R , i} P ( {N}_{M} \vert {R}_{i} ) P ( {R}_{i} \vert {N}_{M} )\end{matrix} ] \qquad [ Equation 11 ]$$

Referring to Equation 11, the matrix multiplication matrix M_{Q} A_{R} M_{F} from the perspective of the repeater is a matrix having a size of M*M, and a value of an element corresponding to the a-th row and b-th column of a corresponding matrix may be expressed as

$${\sum }_{i = 0}^{K} {α}_{R , i} P ( {N}_{a} \vert {R}_{i} ) P ( {R}_{i} \vert {N}_{b} ) .$$

Each element value may be formed as a value obtained by multiplying a probability metric P(Rᵢ|N_{b}) related to a usage rate of a repeater of a communication node N_{b} by a probability metric P(Nₐ|Rᵢ) related to a transmission rate of a communication node Nₐ with respect to the repeater Rᵢ, multiplying the multiplication result by a weight element α_{R,i} related to the repeater Rᵢ, and then adding all values throughout the 0-th to K-th repeaters.

This may indicate that the weight that may reflect the requirements of the user and/or manager may be applied to each repeater in the wireless communication network of an energy management system in the factory, while simultaneously associating the probability metric P(Nₐ|Rᵢ) related to the transmission rate with the probability metric P(Rᵢ|N_{b}) related to the usage rate throughout the 0-th to K-th repeaters.

Accordingly, the present disclosure may train link adaptation from the perspective of the repeater in response to link adaptation in the wireless communication network by setting values of the weight α_{R,i} to reflect the requirements of the user and/or manager or the importance of the repeaters according to the utility or process and by using the matrix multiplication matrix M_{Q}A_{R}M_{F} from the perspective of the repeater as an input of machine learning. In addition, the matrix multiplication matrix M_{Q}A_{R} M_{F} from the perspective of the repeater is a square matrix having a size of M*M, which may have various advantages over general matrices in terms of matrix operations.

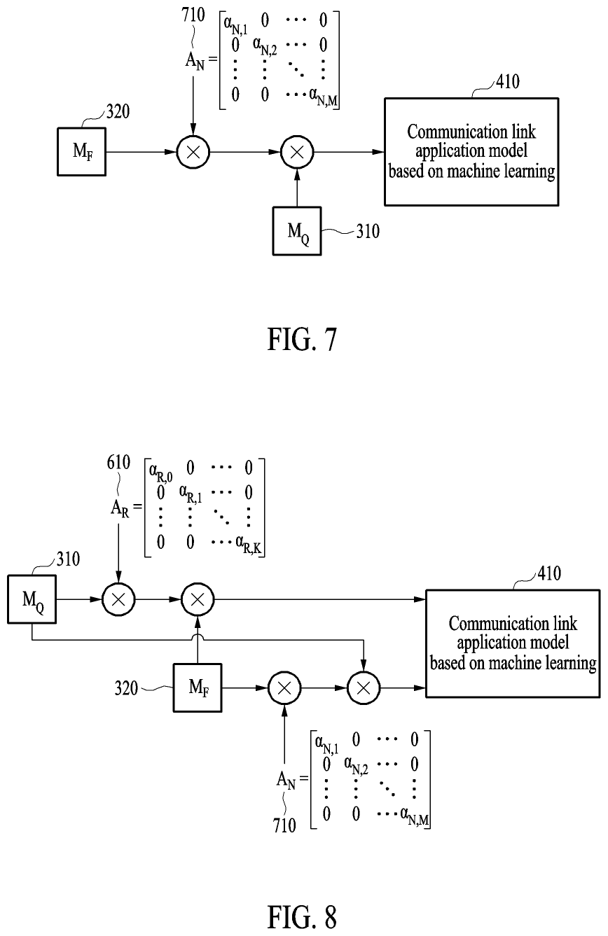

FIG. 7 is a diagram illustrating a process of forming a matrix multiplication matrix using a weighted diagonal matrix from the perspective of a communication node, according to an embodiment.

Referring to FIG. 7, the computing apparatus 140 may perform link adaptation of a communication channel based on data preprocessing by setting a weight from the perspective of the communication node. The present disclosure may generate a matrix multiplication matrix M_{F}A_{N}M_{Q}, which is the weight from the perspective of the communication node, to set a characteristic or goal for more detailed and systematic adaptation of the wireless communication network for each of a plurality of repeaters.

Data preprocessing by setting an input data weight from the perspective of the communication node may be selected and used by a user or manager of a wireless network based on factors, such as an environment, a utility usage condition, and a process priority of a factory where the wireless communication network is built.

To generate the matrix multiplication matrix from the perspective of the communication node, the present disclosure may set a weighted diagonal matrix 710 having a size of M*M with respect to the communication node, as shown in Equation 12 below, similar to Equation 9 described with reference to FIG. 7.

$${A}_{N} = [ \begin{matrix}{α}_{N , 1} & 0 & ⋯ & 0 \\ 0 & {α}_{N , 2} & ⋯ & 0 \\ ⋮ & ⋮ & ⋱ & ⋮ \\ 0 & 0 & ⋯ & {α}_{N , M}\end{matrix} ] \qquad [ Equation 12 ]$$

Referring to Equation 12, the present disclosure may form a matrix structure so that matrix multiplication is possible by sequentially positioning the weighted diagonal matrix with respect to the communication node in the middle between the usage frequency matrix M_{F} 320 and the communication quality matrix M_{Q} 310. This may calculate the matrix multiplication, as shown in Equation 13 below.

$${M}_{F} {A}_{N} {M}_{Q} = [ \begin{matrix}P ( {R}_{0} \vert {N}_{1} ) & P ( {R}_{0} \vert {N}_{2} ) & ⋯ & P ( {R}_{0} \vert {N}_{M} ) \\ P ( {R}_{1} \vert {N}_{1} ) & P ( {R}_{1} \vert {N}_{2} ) & ⋯ & P ( {R}_{1} \vert {N}_{M} ) \\ ⋮ & ⋮ & ⋱ & ⋮ \\ P ( {R}_{K} \vert {N}_{1} ) & P ( {R}_{K} \vert {N}_{2} ) & ⋯ & P ( {R}_{K} \vert {N}_{M} )\end{matrix} ] [ \begin{matrix}{α}_{N , 1} & 0 & ⋯ & 0 \\ 0 & {α}_{N , 2} & ⋯ & 0 \\ ⋮ & ⋮ & ⋱ & ⋮ \\ 0 & 0 & ⋯ & {α}_{N , M}\end{matrix} ] [ \begin{matrix}P ( {N}_{1} \vert {R}_{0} ) & P ( {N}_{1} \vert {R}_{1} ) & ⋯ & P ( {N}_{1} \vert {R}_{K} ) \\ P ( {N}_{2} \vert {R}_{0} ) & P ( {N}_{2} \vert {R}_{1} ) & ⋯ & P ( {N}_{2} \vert {R}_{K} ) \\ ⋮ & ⋮ & ⋱ & ⋮ \\ P ( {N}_{M} \vert {R}_{0} ) & P ( {N}_{M} \vert {R}_{1} ) & ⋯ & P ( {N}_{M} \vert {R}_{K} )\end{matrix} ] \qquad [ Equation 13 ]$$

In addition, the matrix multiplication matrix M_{F}A_{N}M_{Q} from the perspective of the communication node in Equation 13 may be solved as shown in Equation 14 below.

$${M}_{F} {A}_{N} {M}_{Q} = [ \begin{matrix}{\sum }_{j = 1}^{M} {α}_{N , j} P ( {R}_{0} \vert {N}_{j} ) P ( {N}_{j} \vert {R}_{0} ) & {\sum }_{j = 1}^{M} {α}_{N , j} P ( {R}_{0} \vert {N}_{j} ) P ( {N}_{j} \vert {R}_{1} ) & ⋯ & {\sum }_{j = 1}^{M} {α}_{N , j} P ( {R}_{0} \vert {N}_{j} ) P ( {N}_{j} \vert {R}_{K} ) \\ {\sum }_{j = 1}^{M} {α}_{N , j} P ( {R}_{1} \vert {N}_{j} ) P ( {N}_{j} \vert {R}_{0} ) & {\sum }_{j = 1}^{M} {α}_{N , j} P ( {R}_{1} \vert {N}_{j} ) P ( {N}_{j} \vert {R}_{1} ) & ⋯ & {\sum }_{j = 1}^{M} {α}_{N , j} P ( {R}_{1} \vert {N}_{j} ) P ( {N}_{j} \vert {R}_{K} ) \\ ⋮ & ⋮ & ⋱ & ⋮ \\ {\sum }_{j = 1}^{M} {α}_{N , j} P ( {R}_{K} \vert {N}_{j} ) P ( {N}_{j} \vert {R}_{0} ) & {\sum }_{j = 1}^{M} {α}_{N , j} P ( {R}_{K} \vert {N}_{j} ) P ( {N}_{j} \vert {R}_{1} ) & ⋯ & {\sum }_{j = 1}^{M} {α}_{N , j} P ( {R}_{K} \vert {N}_{j} ) P ( {N}_{j} \vert {R}_{K} )\end{matrix} ] . \qquad [ Equation 14 ]$$

Referring to Equation 14, the matrix multiplication matrix M_{F} A_{N}M_{Q} from the perspective of the communication node is a matrix having a size of (K+1)*(K+1), and a value of an element corresponding to the a+1-th row and b+1-th column of a corresponding matrix may be expressed as

$${\sum }_{j = 1}^{M} {α}_{N , j} P ( {R}_{a} \vert {N}_{j} ) P ( {N}_{j} \vert {R}_{b} ) .$$

Each element value may be forms as a value obtained by multiplying a probability metric P(Nⱼ|Rᵢ) related to a transmission rate of a repeater R_{b} by a probability metric P(Rₐ|Nⱼ) related to a usage rate of a repeater Rₐ with respect to the communication node Nⱼ, multiplying the multiplication result by a weigh element α_{N,j} related to the communication node Nⱼ, and then adding all values throughout the 1-th to M-th communication nodes.

This may indicate that the weight α_{N,j} that may reflect the requirements of the user and/or manager may be applied to the repeaters while simultaneously associating the probability metric P(Nⱼ|R_{b}) related to the transmission rate of the repeater R_{b} with the probability metric P(Rₐ|Nⱼ) related to the usage rate of the repeater Rₐ throughout the 1-th to M-th communication nodes.

Accordingly, the present disclosure may train link adaptation from the perspective of the communication node in response to link adaptation in the wireless communication network by setting values of the weight α_{N,j} to reflect the requirements of the user and/or manager or the importance of the communication nodes according to the utility or process and by using the matrix multiplication matrix M_{F} A_{N}M_{Q} from the perspective of the communication node as an input of machine learning. In addition, the matrix multiplication matrix M_{F}A_{N}M_{Q} from the perspective of the communication node is a square matrix having a size of M*M, which may have various advantages over general matrices in terms of matrix operations.

FIG. 8 is a diagram illustrating a process of performing an application of a weight for data preprocessing, according to an embodiment.

Referring to FIG. 8, the computing apparatus 140 may perform data preprocessing from the perspective of a repeater and the perspective of a communication node. Specifically, considering various factory environments, the computing apparatus 140 may perform data preprocessing more efficiently from the perspective of the repeater and the perspective of the communication node by simultaneously applying each of the weighted diagonal matrices 610 and 710.

Here, as the matrix multiplication matrix from the perspective of the repeater and the matrix multiplication matrix from the perspective of the communication node, which are described with reference to FIGS. 6 and 7, are input as input values of the communication link application model based on machine learning 410, the present disclosure may find a loss section of a communication link that may occur due to various environmental variables and situations, while systematically reflecting the requirements of a user and manager.

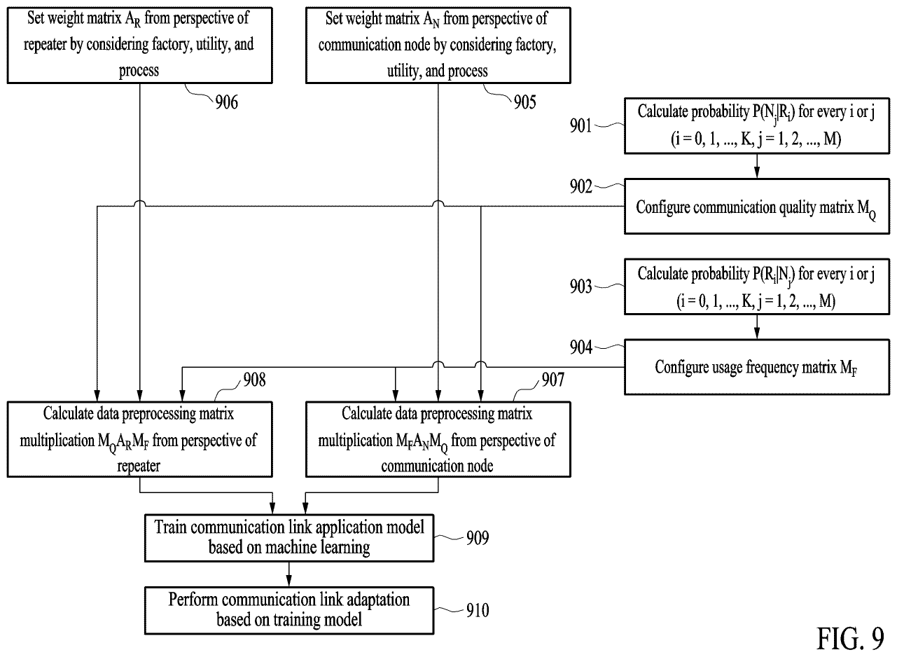

FIG. 9 is a flowchart illustrating a communication link search method according to an embodiment.

In operation 901, the computing apparatus 140 may generate a non-error conditional probability of a wireless communication signal that is transmitted from a communication node when an i-th repeater is included in a communication path. The non-error conditional probability may be a numerical representation of the transmission quality using the number of packets including the i-th repeater in the communication path and the number of error packets among the number of packets including the i-th repeater in the communication path. This is described in detail with reference to FIG. 3.

In operation 902, the computing apparatus 140 may generate a communication quality matrix indicating the transmission quality of the wireless communication signal that is transmitted from the communication node based on a repeater according to the communication path that is established between the communication node and the repeater in a wireless communication network according to the non-error conditional probability.

In operation 903, the computing apparatus 140 may generate a selection conditional probability of whether the i-th repeater is included in the communication path when the wireless communication signal is transmitted from the communication node. The selection conditional probability may be a numerical representation of whether the wireless communication signal passes through the repeater in the process of transmitting the wireless communication signal using the non-error conditional probability of the wireless communication signal that is transmitted from the communication node and a reference probability that the i-th repeater is included in the communication path, based on the non-error conditional probability of the communication node that is linked to a j-th control point. This is described in detail with reference to FIG. 3.

In operation 904, based on the communication node, the computing apparatus 140 may generate a usage frequency matrix indicating the frequency of use of whether the wireless communication signal that is transmitted from the communication node passes through the repeater.

In operation 905, the computing apparatus 140 may generate a weight matrix from the perspective of a communication node. This is described in detail with reference to FIG. 7.

In operation 906, the computing apparatus 140 may generate a weight matrix from the perspective of a repeater. This is described in detail with reference to FIG. 6.

In operation 907, the computing apparatus 140 may generate a matrix multiplication matrix to perform data preprocessing from the perspective of the repeater by performing matrix multiplication in the order of the usage frequency matrix, the weight matrix of the repeater, and the communication quality matrix. This is described in detail with reference to FIG. 6.

In operation 908, the computing apparatus 140 may generate a matrix multiplication matrix to perform data preprocessing from the perspective of the communication node by performing matrix multiplication in the order of the communication quality matrix, the weight matrix of the communication node, and the usage frequency matrix. This is described in detail with reference to FIG. 7.

In operation 909, the computing apparatus 140 may perform training on the matrix multiplication matrix from the perspective of the repeater and the matrix multiplication matrix from the perspective of the communication node using a communication link application model based on machine learning.

In operation 910, the computing apparatus 140 may determine, through the communication link application model, a characteristic of the transmission quality of the wireless communication signal that is transmitted from the communication node on which data preprocessing is performed. The computing apparatus 140 may extract a communication quality pattern corresponding to the determined characteristic of the transmission quality. In addition, the computing apparatus 140 may determine a characteristic of communication connectivity of the repeater on which data preprocessing is performed, by applying the communication quality pattern to the communication link application model. The computing apparatus 140 may extract the communication quality pattern corresponding to the determined characteristic of the communication connectivity.

The computing apparatus 140 may determine, by analyzing the communication quality pattern and the usage frequency pattern, whether there is at least one point where the transmission quality of the wireless communication signal that is transmitted from the communication node is less than or equal to a preset first threshold value or where the frequency of use of the repeater is greater than or equal to a preset second threshold value. The computing apparatus 140 may search for a point where loss of a communication link occurs in the wireless communication network based on the determination result.

FIG. 10 is a diagram illustrating a communication link that may be set between pieces of communication terminal equipment including a communication node, a repeater, and a gateway, according to an embodiment.

Referring to FIG. 10, the communication link may be formed between pieces of communication terminal equipment, such as between a communication node 1010 and a repeater 1020, between different repeaters 1030, rather than between the repeater 1020 and the same repeater 1020, between the communication node 1010 and a gateway 1040, and between the repeater 1030 and the gateway 1040. Here, the predetermined repeater 1020 and the different repeaters 1030 are shown in separate forms to describe the relationship in which the communication link is performed by the same repeater. For example, the communication link may be performed between different repeaters 1060, except for a predetermined repeater 1050 and the predetermined repeater 1050 among the repeaters 1020.

As described above, the communication link may be performed bidirectionally between the pieces of communication terminal equipment. The present disclosure may divide the communication terminal equipment into source terminal equipment and destination terminal equipment based on the aspect of monitoring energy data in a factory, utility, process, or the like.

The source terminal equipment is equipment that performs a function of transmitting energy data and may include the communication node 1010, which intends to transmit energy data to a gateway by interoperating with a control point measuring instrument, and the repeater 1020, which relays a communication signal to enable communication between distant points or in a place with poor channel quality.

The destination terminal equipment is equipment that performs a function of receiving energy data and may include the repeaters 1020 and 1030, which receive a communication signal from the communication node 1010 or the repeater 1020 and relay the communication signal to the other repeater 1030 or the gateway 1040, or the gateway 1040, which receives energy data from the communication node 1010 or the repeaters 1020 and 1030.

Based on this relationship, the present disclosure may set the communication link between the pieces of communication terminal equipment in terms of the flow through which energy data is transmitted. That is, FIG. 10 illustrates the communication link between the pieces of communication terminal equipment, and in FIG. 10, L_{pq} may be a link metric for a communication link that is performed between two pieces of communication terminal equipment. Here, p denotes an index of the communication node 1010 and the repeater 1020 included in the source terminal equipment and q denotes an index of the repeater 1030 and the gateway 1040 included in the destination terminal equipment.

Ultimately, the index p may be an element of a set S indicating the source terminal equipment that may be designated as the index p, which may be expressed as Equation 15.

$$p ∈ S = \{ {N}_{j} {\vert}_{j = 1 , ⋯ , M} , {R}_{i} {\vert}_{i = 1 , ⋯ , K} \} \qquad [ Equation 15 ]$$

In addition, the index q may be an element of a set D indicating the destination terminal equipment that may be designated as the index q, and which may be expressed as Equation 16.

$$q {\vert}_{q \neq p} ∈ D = \{ {R}_{i} {\vert}_{i = 1 , ⋯ K} , G \} \qquad [ Equation 16 ]$$

Here, G denotes a gateway device and q≠p denotes that the source terminal equipment and the destination terminal equipment are not the same equipment.

Specifically, in the present disclosure, in the number of cases indicating communication links shown in FIG. 10, when one piece of source terminal equipment belonging to the set S indicating the source terminal equipment is selected as the index p and one piece of destination terminal equipment belonging to the set D indicating the destination terminal equipment is selected as the index q, the communication link metric L_{pq} may exist between the two pieces of terminal equipment. As described above, the present disclosure may input data to machine learning through data preprocessing from the perspective of a repeater and the perspective of a communication node based on machine learning that is considered excellent for an application that finds a pattern through training. The present disclosure may perform training by matching link metrics of the communication links between the set S of pieces of source terminal equipment and the set D of pieces of destination terminal equipment. The link metrics of the communication links may be expressed as Equation 17 below.

$${L}_{pq} here , p ∈ S = \{ {N}_{j} {\vert}_{j = 1 , ⋯ , M} , {R}_{i} {\vert}_{i = 1 , ⋯ , K} \} ) , q {\vert}_{q \neq p} ∈ D = \{ {R}_{i} {\vert}_{i = 1 , ⋯ K} , G \} \qquad [ Equation 17 ]$$

Ultimately, the present disclosure may derive a lost communication link due to a poor channel environment that may occur in a factory by considering the relationship between the pieces of communication terminal equipment performing the communication link.

FIG. 11 is a diagram illustrating an outputter of a computing apparatus according to a communication link, according to an embodiment.

Referring to FIG. 11, the present disclosure may provide a result that is available as an output with respect to the computing apparatus based on machine learning for communication link adaptation described with reference to FIGS. 4 to 8. That is, the result illustrated in FIG. 11 may correspond to one output node for each communication link metric L_{pq}.

Ultimately, the present disclosure may find and adaptively overcome the communication link that is degraded due to the poor channel environment that may occur in the factory by performing machine learning for communication link adaptation and finding the communication link metric L_{pq} that is poor, through data preprocessing from the perspective of a repeater and the perspective of a communication node and the output result of the communication link metric L_{pq} shown in FIG. 11.

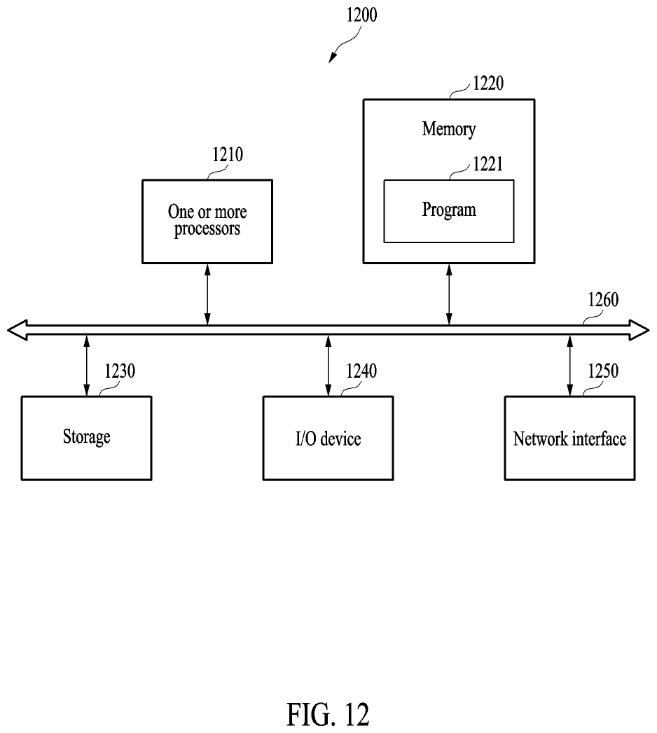

FIG. 12 is a block diagram illustrating an example of a configuration of a computing apparatus that searches for a point where loss of a communication link occurs, according to an embodiment.

Referring to FIG. 12, a computing apparatus 1200 may include one or more processors 1210, a memory 1220, a storage 1230, an input/output (I/O) device 1240, and a network interface 1250. These components may communicate with each other via a communication bus 1260.

The one or more processors 1210 may execute instructions stored in the memory 1220 or the storage 1230. The instructions, when executed by the one or more processors 1210, may cause the computing apparatus 1200 to perform the operations described with reference to FIGS. 1 to 9. The memory 1220 may include a computer-readable storage medium or a computer-readable storage device. The memory 1220 may store instructions to be executed by the one or more processors 1210 and may store related information while software and/or an application is being executed by the computing apparatus 1200. The memory 1220 may store a program 1221 to search for the point where the loss of the communication link occurs and perform link adaptation of an embodiment. When at least a portion of the program 1221 is stored in the memory 1220, the operations described with reference to FIGS. 1 to 9 may be performed by the computing apparatus 1200.

The storage 1230 may include a computer-readable storage medium or a computer-readable storage device. The storage 1230 may store a more quantity of information than the memory 1220 for a long time. For example, the storage 1230 may include a magnetic hard disk, an optical disc, flash memory, a floppy disk, or other non-volatile memories known in this technical field.

The I/O device 1240 may receive an input from a user in traditional input manners through a keyboard and a mouse, and in new input manners such as a touch input, a voice input, and an image input. For example, the I/O device 1240 may include a keyboard, a mouse, a touch screen, a microphone, or any other device that detects the input from the user and transmits the detected input to the computing apparatus 1200. The I/O device 1240 may provide the user with an output of the computing apparatus 1200 through a visual channel, an audio channel, or a tactile channel. The I/O device 1240 may include, for example, a display, a touch screen, a speaker, a vibration generator, or any other device that provides the output to the user. The network interface 1250 may communicate with an external device through a wired or wireless network.

As described above, although the embodiments have been described with reference to the limited drawings, a person skilled in the art may apply various technical modifications and variations based thereon. For example, suitable results may be achieved if the described techniques are performed in a different order, and/or if components in a described system, structure, device, or circuit are combined in a different manner, and/or replaced or supplemented by other components or their equivalents.

Therefore, other implementations, other embodiments, and equivalents to the claims are also within the scope of the following claims.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

What is claimed is:

1. A method of searching for a communication link, the method comprising:
based on a repeater according to a communication path that is established between a communication node and the repeater in a wireless communication network, generating a communication quality matrix indicating a transmission quality of a wireless communication signal that is transmitted from the communication node;
generating, based on the communication node, a usage frequency matrix indicating a frequency of use of whether the wireless communication signal that is transmitted from the communication node passes through the repeater;
extracting a communication quality pattern and a usage frequency pattern in the wireless communication network by applying the communication quality matrix and the usage frequency matrix to a communication link application model based on machine learning; and
searching for a point where loss of the communication link occurs in the wireless communication network by analyzing the communication quality pattern and the usage frequency pattern.

2. The method of claim 1, wherein the generating of the communication quality matrix comprises generating the communication quality matrix indicating the transmission quality of the wireless communication signal using a non-error conditional probability of the wireless communication signal that is transmitted from the communication node when an i-th repeater is comprised in the communication path.

3. The method of claim 2, wherein the non-error conditional probability is a numerical representation of the transmission quality using a number of packets comprising the i-th repeater in the communication path and a number of error packets among the number of packets comprising the i-th repeater in the communication path.

4. The method of claim 1, wherein the generating of the usage frequency matrix comprises generating the usage frequency matrix indicating the frequency of use using a selection conditional probability of whether an i-th repeater is comprised in the communication path when the wireless communication signal is transmitted from the communication node.

5. The method of claim 4, wherein the selection conditional probability is a numerical representation of whether the wireless communication signal passes through the repeater in a process of transmitting the wireless communication signal using a non-error conditional probability of the wireless communication signal that is transmitted from the communication node and a reference probability that the i-th repeater is comprised in the communication path, based on a non-error conditional probability of a communication node that is linked to a j-th control point.

6. The method of claim 1, wherein the extracting of the communication quality pattern and the usage frequency pattern comprises extracting the communication quality pattern related to a transmission rate of the communication node based on the repeater by applying the communication quality matrix to the communication link application model.

7. The method of claim 1, wherein the extracting of the communication quality pattern and the usage frequency pattern comprises extracting the usage frequency pattern related to communication connectivity of the repeater that is repeatedly used in the wireless communication network based on the communication node by applying the usage frequency matrix to the communication link application model.

8. The method of claim 1, wherein the extracting of the communication quality pattern and the usage frequency pattern comprises:
generating a weight matrix of the communication node;
generating a weight matrix of the repeater;
generating a first matrix multiplication matrix to perform data preprocessing using the weight matrix of the communication node, the communication quality matrix, and the usage frequency matrix; and
generating a second matrix multiplication matrix to perform data preprocessing using the weight matrix of the repeater, the communication quality matrix, and the usage frequency matrix.

9. The method of claim 8, wherein the extracting of the communication quality pattern and the usage frequency pattern comprises:
determining a characteristic of the transmission quality of the wireless communication signal that is transmitted from the communication node on which data preprocessing is performed, by applying the first matrix multiplication matrix and the second matrix multiplication matrix to the communication link application mode; and
extracting the communication quality pattern corresponding to the determined characteristic of the transmission quality.

10. The method of claim 8, wherein the extracting of the communication quality pattern and the usage frequency pattern comprises:
determining a characteristic of communication connectivity of the repeater on which data preprocessing is performed, by applying the first matrix multiplication matrix and the second matrix multiplication matrix to the communication link application model; and
extracting the communication quality pattern corresponding to the determined characteristic of the communication connectivity.

11. The method of claim 1, wherein the searching for the point where the loss of the communication link occurs comprises:
by analyzing the communication quality pattern and the usage frequency pattern, determining whether there is at least one point where the transmission quality of the wireless communication signal that is transmitted from the communication node is less than or equal to a preset first threshold value or where a frequency of use of the repeater is greater than or equal to a preset second threshold value; and
searching for the point where the loss of the communication link occurs in the wireless communication network based on a determination result.

12. A computing apparatus for performing a communication link search method, the computing apparatus comprising:
a processor,
wherein the processor is configured to:
based on a repeater according to a communication path that is established between a communication node and the repeater in a wireless communication network, generate a communication quality matrix indicating a transmission quality of a wireless communication signal that is transmitted from the communication node;
generate, based on the communication node, a usage frequency matrix indicating a frequency of use of whether the wireless communication signal that is transmitted from the communication node passes through the repeater;
extract a communication quality pattern and a usage frequency pattern in the wireless communication network by applying the communication quality matrix and the usage frequency matrix to a communication link application model based on machine learning; and
search for a point where loss of a communication link occurs in the wireless communication network by analyzing the communication quality pattern and the usage frequency pattern.

13. The computing apparatus of claim 12, wherein the processor is configured to generate the communication quality matrix indicating the transmission quality of the wireless communication signal using a non-error conditional probability of the wireless communication signal that is transmitted from the communication node when an i-th repeater is comprised in the communication path.

14. The computing apparatus of claim 12, wherein the processor is configured to generate the usage frequency matrix indicating the frequency of use using a selection conditional probability of whether an i-th repeater is comprised in the communication path when the wireless communication signal is transmitted from the communication node.

15. The computing apparatus of claim 12, wherein the processor is configured to extract the communication quality pattern related to a transmission rate of the communication node based on the repeater by applying the communication quality matrix to the communication link application model.

16. The computing apparatus of claim 12, wherein the processor is configured to extract the usage frequency pattern related to communication connectivity of the repeater that is repeatedly used in the wireless communication network based on the communication node by applying the usage frequency matrix to the communication link application model.

17. The computing apparatus of claim 12, wherein the processor is configured to:
generate a weight matrix of the communication node;
generate a weight matrix of the repeater;
generate a first matrix multiplication matrix to perform data preprocessing using the weight matrix of the communication node, the communication quality matrix, and the usage frequency matrix; and
generate a second matrix multiplication matrix to perform data preprocessing using the weight matrix of the repeater, the communication quality matrix, and the usage frequency matrix.

18. The computing apparatus of claim 17, wherein the processor is configured to:
determine a characteristic of the transmission quality of the wireless communication signal that is transmitted from the communication node on which data preprocessing is performed, by applying the first matrix multiplication matrix and the second matrix multiplication matrix to the communication link application model;
extract the communication quality pattern corresponding to the determined characteristic of the transmission quality;
determine a characteristic of communication connectivity of the repeater on which data preprocessing is performed, by applying the first matrix multiplication matrix and the second matrix multiplication matrix to the communication link application model; and
extract the communication quality pattern corresponding to the determined characteristic of the communication connectivity.

19. The computing apparatus of claim 12, wherein the processor is configured to:
by analyzing the communication quality pattern and the usage frequency pattern, determine whether there is at least one point where the transmission quality of the wireless communication signal that is transmitted from the communication node is less than or equal to a preset first threshold value or where a frequency of use of the repeater is greater than or equal to a preset second threshold value; and
search for the point where the loss of the communication link occurs in the wireless communication network based on a determination result.

20. A system for managing energy, the system comprising:
at least one communication node configured to transmit a wireless communication signal in a wireless communication network by interoperating with a control point;
at least one repeater configured to receive the wireless communication signal that is transmitted from the at least one communication node or configured to retransmit the transmitted wireless communication signal according to a communication path that is established in the wireless communication signal;
a gateway configured to receive the wireless communication signal from the at least one communication node and the at least one repeater; and
a computing apparatus configured to search for a point where loss of a communication link occurs by identifying a connection state of the communication link among the at least one communication node, the at least one repeater, and the gateway,
wherein the computing apparatus is configured to:
based on the at least one repeater according to the communication path that is established between the least one communication node and the at least one repeater in the wireless communication network, generate a communication quality matrix indicating a transmission quality of the wireless communication signal that is transmitted from the least one communication node;
generate, based on the least one communication node, a usage frequency matrix indicating a frequency of use of whether the wireless communication signal that is transmitted from the least one communication node passes through the at least one repeater;
extract a communication quality pattern and a usage frequency pattern in the wireless communication network by applying the communication quality matrix and the usage frequency matrix to a communication link application model based on machine learning; and
search for the point where the loss of the communication link occurs in the wireless communication network by analyzing the communication quality pattern and the usage frequency pattern.
